(19) United States
(12) Patent Application Publication
(10) Pub. No.: US 2024/0417247 A1
(43) Pub. Date: Dec. 19, 2024

(54) HYDROGEN PRODUCTION APPARATUS AND HYDROGEN PRODUCTION METHOD

(71) Applicant: NIPPON COKE & ENGINEERING CO., LTD., Tokyo (JP)

(72) Inventor: Satoshi SHIINA, Tochigi (JP)

(21) Appl. No.: 18/690,690

(22) PCT Filed: Jul. 1, 2022
(86) PCT No.: PCT/JP2022/026492

§ 371 Date: Mar. 8, 2024

(30) Foreign Application Priority Data
Sep. 13, 2021 (JP) 2021-148933

(51) Int. Cl. C01B 3/04; B02C 17/16; B02C 23/36

(52) U.S. Cl. CPC C01B 3/042; B02C 17/16; B02C 23/36

(57) ABSTRACT

Provided is a hydrogen production apparatus that enables the production of large amounts of hydrogen at low electric power. The hydrogen production apparatus (1) produces hydrogen by a mechanochemical reaction between water and a treatment object that is an inorganic substance. Then, it is equipped with a grinding mill (2) that has a supply port (22) and a discharge port (23) of the treatment object and a cylindrical grinding container (21); a holding tank (3) of the treatment object that is treated by the grinding mill; and a circulation line (40) that circulates the treatment object and water between the grinding mill and the holding tank. Herein, the ratio (L/D) of a length (L) in an axial direction to a diameter (D) of a grinding chamber that is formed in the grinding container is preferably equal to or less than 1, more preferably equal to or less than ⅓.

### CROSS-REFERENCE TO RELATED APPLICATIONS

This application is the national phase of PCT Application No. PCT/JP2022/026492, filed Jul. 1, 2022, which claims the benefit of priority from Japanese Patent Application No. 2021-148933, filed Sep. 13, 2021, the disclosures of which are incorporated herein by reference in their entireties.

### TECHNICAL FIELD

The present invention relates to a hydrogen production apparatus and a hydrogen production method, for producing hydrogen by a mechanochemical reaction between water and a treatment object that is an inorganic substance.

### BACKGROUND

There are various methods for producing hydrogen, and the water electrolysis method is promising as a method for producing hydrogen from renewable energy. However, the water electrolysis method consumes large amounts of electricity and has the problem that the purity of hydrogen gas decreases when the electricity is not stable, especially in the alkali type.

On the other hand, as disclosed in Japanese Patent Application Publication 2016-47789 and Japanese Patent Application Publication 2017-141157, it is known that hydrogen is generated by a mechanochemical reaction simply by putting water and iron-based grinding media into a planetary ball mill container, followed by agitation.

Here, when considering the mass production of hydrogen by mechanochemical reaction, it is difficult to scale up by using a planetary ball mill, and its production efficiency is also low. Furthermore, Japanese Patent Application Publication 2016-47789 also describes that it is possible to generate hydrogen by adding silicon and sodium hydroxide to water, followed by grinding with a planetary ball mill.

### SUMMARY

However, in the case of adding sodium hydroxide to a water slurry of silicon while grinding, it is necessary to add sodium hydroxide of an optimum concentration in accordance with the particle size (specific surface area) of silicon when added. For example, if it is thinner than the optimum concentration, the hydrogen gas production decreases.

On the other hand, if sodium hydroxide is added at a concentration thicker than the optimum concentration, the temperature rises due to an abrupt reaction, and a large amount of a hydrogen-containing gas is generated in a short period of time, thereby causing the slurry to swell up like a hard caramelized sugar candy. Then, the slurry and solids may flow out of the treatment tank (holding tank), and the solids may adhere to the inside of the tank or of the grinding mill to interfere with the operation.

In addition, there is a demand for hydrogen generators that operate at lower electric powers, in the case of assuming the use of renewable energy such as solar power generation and wind power generation.

It is therefore an object of the present invention to provide a hydrogen production apparatus and a hydrogen production method, which enable the production of large amounts of hydrogen at low electric power.

For achieving the above object, a hydrogen production apparatus of the present invention is a hydrogen production apparatus for producing hydrogen by a mechanochemical reaction between water and a treatment object that is an inorganic substance. It is characterized by being equipped with a media-agitating-type wet grinding mill that has a supply port and a discharge port of the treatment object and a cylindrical grinding container; a holding tank of the treatment object that is treated by the media-agitating-type wet grinding mill; and a circulation line that circulates the treatment object and water between the media-agitating-type wet grinding mill and the holding tank.

Herein, it can be configured such that a ratio (L/D) of a length (L) in an axial direction to a diameter (D) of a grinding chamber that is formed in the grinding container is equal to or less than 1. Furthermore, the ratio (L/D) of the length (L) in the axial direction to the diameter (D) of the grinding chamber is preferably equal to or less than ⅓.

It may be configured such that two agitating rotors that are attached to a rotary shaft to have a space therebetween in the axial direction are disposed in the grinding chamber, and that the agitating rotor is equipped with a disk-shape holding plate portion that is fixed to the rotary shaft and has a plurality of openings, a cylindrical agitating portion that is provided at a periphery of the holding plate portion and has a plurality of through holes, and a projection portion that is provided on an outer circumferential surface of the agitating portion.

The holding tank can be configured to be a large capacity tank that is formed to have a volumetric capacity 300 or more times that of the grinding chamber formed in the grinding container. The treatment object can be one containing at least one kind selected from the group consisting of silicon, aluminum, iron, germanium, tin, titanium, calcium, zinc, chromium, manganese, zirconium, strontium, silver, phosphorus, magnesium, vanadium, nickel, molybdenum, copper, tungsten, cobalt, lithium, barium, sodium, potassium, and rubidium.

It can be configured to be equipped with a reaction tank having a port to add an alkali component or an acid component, and a feed line that is connected to the circulation line to feed the treatment object to the reaction tank.

The invention of hydrogen production method is a hydrogen production method for producing hydrogen by a mechanochemical reaction between water and a treatment object that is an inorganic substance. It is characterized by including the steps of conducting a grinding treatment by circulating the treatment object and water between a media-agitating-type wet grinding mill that has a cylindrical grinding container and a holding tank; and generating a hydrogen gas by adding an alkali component or an acid component to the treatment object that has been subjected to the grinding treatment and water.

### BRIEF DESCRIPTION OF THE DRAWINGS

FIG. 1 is a schematic explanatory view of a hydrogen production apparatus according to an embodiment of the present invention. FIG. 2 is an explanatory view showing a configuration surrounding the grinding container of the grinding mill. FIG. 3 is an explanatory view showing a configuration of the agitating rotor that is disposed in the grinding chamber of the grinding container. FIG. 4 is a graph showing experiment results obtained by a comparison of the generated hydrogen amount variation according to the types of the media-agitating-type wet grinding mill and the grinding condition. FIG. 5 is a graph showing experiment results obtained by a comparison of the electric amount variation according to the types of the media-agitating-type wet grinding mill and the grinding condition. FIG. 6 is an explanatory view showing a configuration surrounding the grinding container of the grinding mill according to First Embodiment. FIG. 7 is a plan view explaining a configuration of the agitating rotor that is to be disposed in the grinding chamber of the grinding container. FIG. 8 is a side view taken along a direction of arrows A-A of FIG. 7. FIG. 9A is an explanatory view of a configuration of the hydrogen production apparatus according to Second Embodiment. FIG. 9B is an explanatory view of a configuration in which a small capacity tank is disposed for showing a comparison with the hydrogen production apparatus according to Second Embodiment. FIG. 10 is a schematic explanatory view of the hydrogen production apparatus according to Third Embodiment.

### DESCRIPTION OF EMBODIMENT

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

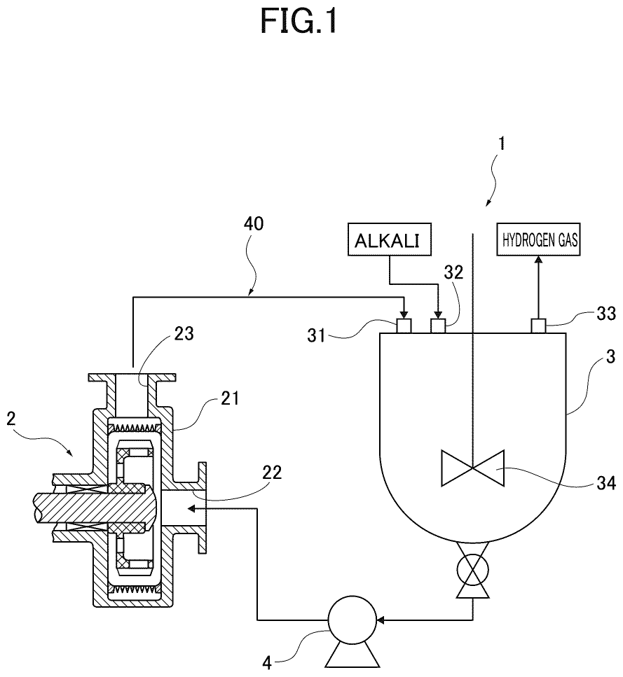

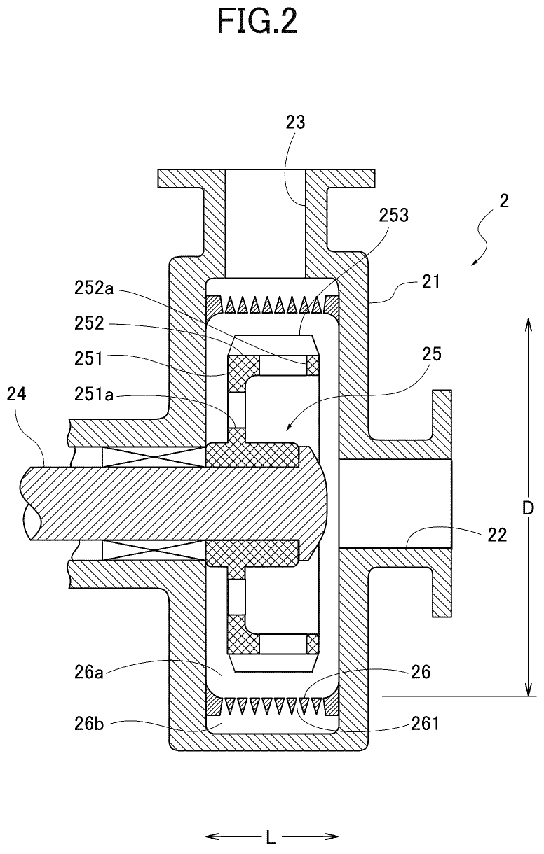

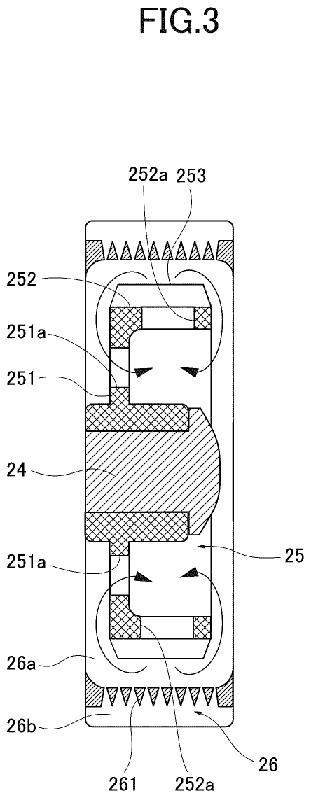

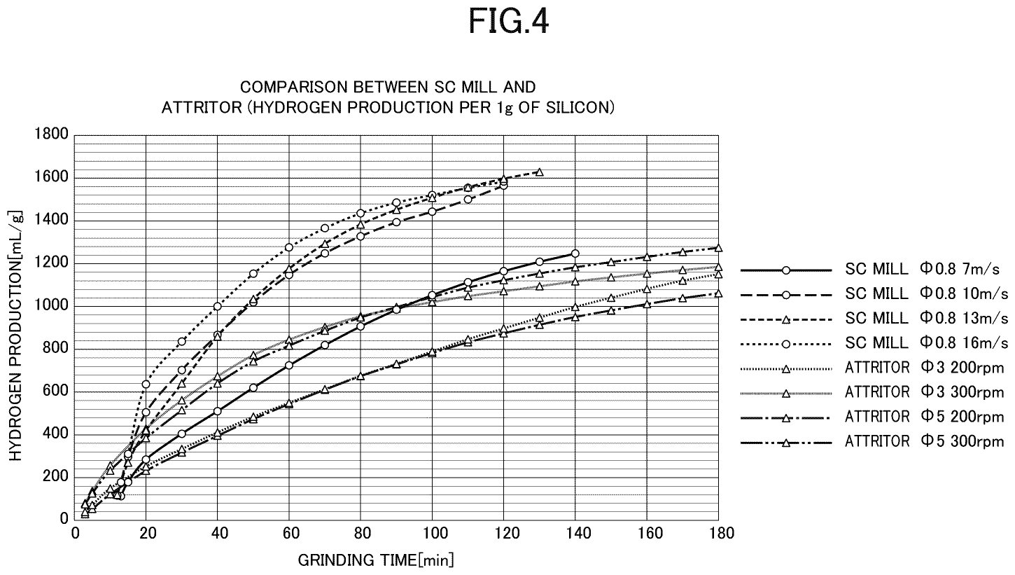

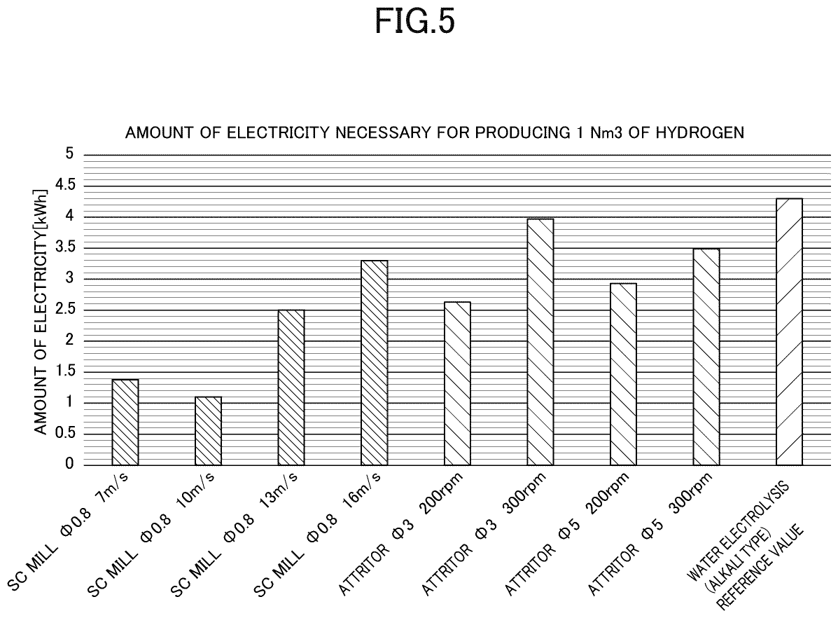

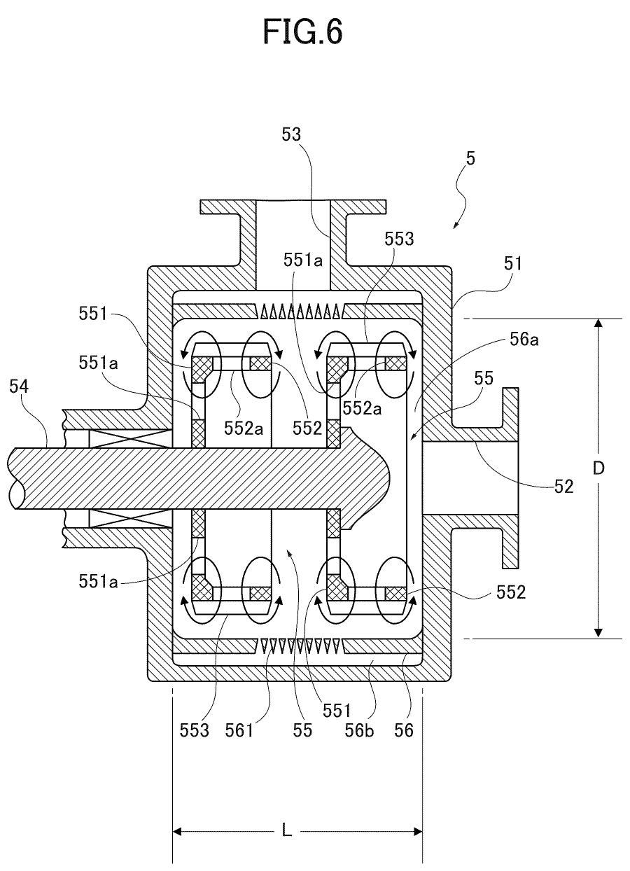

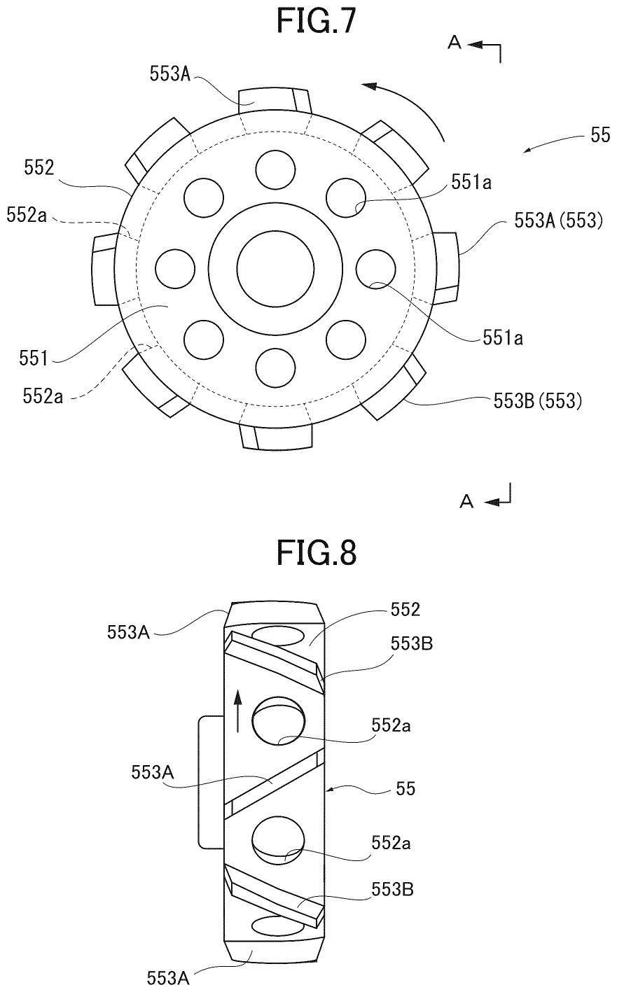

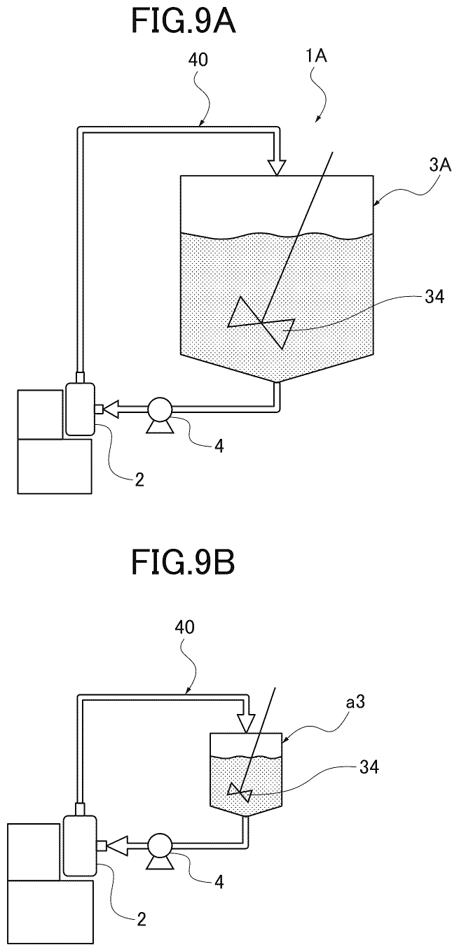

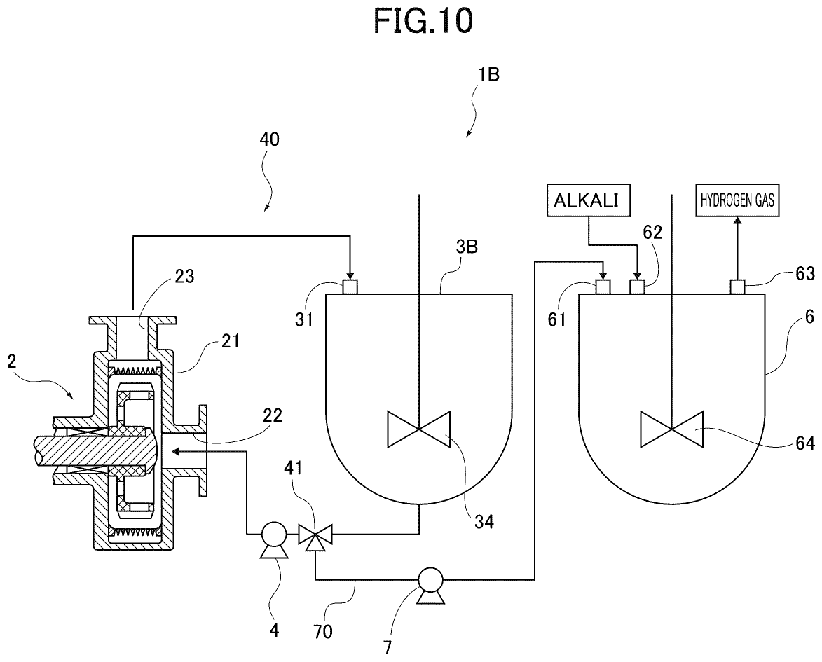

In the following, an embodiment of the present invention is explained with reference to the drawings. FIG. 1 is a schematic explanatory view of a hydrogen production apparatus 1 according to the present embodiment. The hydrogen production apparatus 1 according to the present embodiment is an apparatus for producing hydrogen by a mechanochemical reaction between water and the treatment object that is an inorganic substance.

The hydrogen production apparatus 1 according to the present embodiment is equipped with a grinding mill 2 that is a media-agitating-type wet grinding mill, a holding tank 3 of the treatment object that is an inorganic substance, and a circulation line 40. Firstly, the media-agitating-type wet grinding mill is explained.

Wet grinding treatment refers to a treatment of subjecting solid particles contained in slurry to fine grinding to make a dispersion liquid containing finer particles. Media-agitating-type wet grinding mill refers to a grinding mill in which a slurry treatment liquid and media (grinding media or agitating media) are agitated together in a container to subject the particles to fine grinding by shear force and impact force of the media.

The grinding mill 2 according to the present embodiment is equipped with a cylindrical grinding container 21, a supply port 22 for supplying solid particles of an inorganic substance and water into an inner space of the grinding container 21, and a discharge port 23 for discharging a mixture (treatment object slurry) of the inorganic substance (treatment object) subjected to grinding in the grinding container 21 and water.

In case of using the grinding mill 2 as an apparatus for producing hydrogen by a mechanochemical reaction between water and an inorganic substance, solid particles of the inorganic substance containing at least one kind selected from the group consisting of silicon, aluminum, iron, germanium, tin, titanium, calcium, zinc, chromium, manganese, zirconium, strontium, silver, phosphorus, magnesium, vanadium, nickel, molybdenum, copper, tungsten, cobalt, lithium, barium, sodium, potassium, and rubidium are put in from the supply port 22.

As shown in FIG. 2, the grinding mill 2 is equipped with the cylindrical grinding container 21, a rotary shaft 24 that passes through one side surface of the grinding container 21 and is rotatably installed, and an agitating rotor 25 that rotates while fixed to the rotary shaft 24. That is, the solid particles of the inorganic substance that have been put in together with water from the supply port 22 are agitated with media in a grinding chamber 26a of the grinding container 21 by the rotation of the agitating rotor 25.

Herein, for the media that become the grinding media (agitating media), it is possible to use beads of a material such as tungsten carbide, zirconia, stainless steel, alumina, and silicon nitride. The smaller the particle size of the media, the larger the specific surface area, and thus the higher the grinding capability.

For example, a media-agitating-type wet grinding mill having a model name “SC Mill” is capable of conducting a grinding treatment against the treatment object to have a particle size of from 0.01 μm to 0.1 μm by using beads (media) having a particle size of from 0.2 mm to 0.8 mm. Furthermore, a media-agitating-type wet grinding mill having a model name “MSC Mill” is capable of conducting a grinding treatment against the treatment object to have a particle size of from 0.001 μm to 0.1 μm by using microbeads (media) having a particle size of from 0.03 mm to 0.2 mm.

The above-mentioned media selected to be suited for the treatment object are accommodated in the grinding chamber 26a of the grinding container 21. An inner space of the grinding container 21 is divided into the grinding chamber 26a at its center and an outer part 26b at its periphery by a cylindrical separator 26. For the separator 26, it is possible to use, for example, a screen type provided with many slits 261.

Due to installation of the separator 26, it is possible to prevent leaking of the media from the grinding chamber 26a to the outer part 26b. The separator 26 allows a mixture (treatment object slurry) of water and the inorganic substance grinded to be equal to or smaller than a predetermined particle size to pass therethrough. The treatment object slurry (treatment liquid) flowing out into the outer part 26b is discharged to the outside from the discharge port 23 provided in the grinding container 21.

Herein, the ratio (L/D) of a length (L) in an axial direction to a diameter (D) of the grinding chamber 26a that is formed in the grinding container 21 is preferably equal to or less than 1. In FIG. 2, the ratio (L/D) of the length (L) in an axial direction to the diameter (D) of grinding chamber 26a is ⅓ which is a more preferable ratio. The above-mentioned model name “SC Mill” has this ratio.

These dimensional relationships (L/D) allow the agitating rotor 25 to give the maximum kinetic energy to the treatment object and the media in a limited space. By making the ratio (L/D) as small as ⅓ or less, the dispersion force is increased, and the media's unevenness is less likely to occur, while allowing a higher flow rate.

The grinding mill 2 such as the model name “SC Mill” acts like a centrifugal pump. Therefore, even if a pump is not installed in the circulation line 40, the grinding mill 2 itself acts as a pump and can circulate the treatment object and water in the circulation line 40. However, this does not mean that the pump becomes unnecessary in all cases. In the case of using a large media-agitating-type wet grinding mill or depending on the type of the treatment object such as a highly viscous fluid, a circulation pump 4 is disposed in the circulation line 40 to conduct a stable operation.

FIG. 3 is an explanatory view showing a configuration of the agitating rotor 25 that is disposed in the grinding chamber 26a of the grinding container 21. The agitating rotor 25 is equipped with a disk-shape holding plate portion 251 that is fixed to the rotary shaft 24, a cylindrical agitating portion 252 that is provided at a periphery of the holding plate portion 251, and a plurality of projection portions 253 that are provided on an outer circumferential surface of the agitating portion 252.

The disk-shape holding plate portion 251 is perforated to have a plurality of openings 251a, thereby allowing the treatment object and the media to flow in an axial direction in and out of the agitating rotor 25. Furthermore, it is perforated to have a plurality of through holes 252a each between the projection portions 253 of the agitating portion 252. When the agitating rotor 25 rotates, the treatment object and the media receive a rotational force by front surfaces of the projection portions 253 and receive a strong centrifugal force in the vicinities of the through holes 252a. That is, the treatment object and the media pass through individual through holes 252a by a centrifugal force to flow from the inside toward the outside of the agitating rotor 25, thereby generating a circulation flow at each through hole 252a.

That is, in the grinding chamber 26a of the grinding container 21, there occur strong circulation flows flowing like arrows. This is to ensure that the treatment object and the media are subjected to receive a favorable force action by the rotation of the agitating rotor 25. Then, the treatment object and the media are vigorously agitated throughout the grinding chamber 26a. With this, it is possible to stably conduct a highly efficient grinding treatment.

To the thus configured grinding mill 2, as shown in FIG. 1, the holding tank 3 is connected. The holding tank 3 is a charging tank that is charged with a treatment object slurry (treatment liquid) containing solid particles of the inorganic substance (treatment object) and water, and is also a treatment tank into which the treatment object slurry that has been grinded by the grinding mill 2 is allowed to flow.

In a circulation mode, the holding tank 3 and the grinding mill 2 are connected by the circulation line 40. According to need, a circulation pump 4 is disposed in the circulation line 40. The treatment object slurry that has been fed into the holding tank 3 from a feeding port 31 is agitated by an agitator 34 to maintain a uniform concentration.

Then, the treatment object slurry is taken out of a bottom of the holding tank 3, then is sent to the grinding mill 2 by the circulation line 40, then is subjected here to the agitation and grinding treatments, and then is returned to the holding tank 3 from the feeding port 31 by the circulation line 40.

In a condition in which the treatment object is circulated in this manner, the grinding treatment is conducted for a predetermined period of time. By conducting the circulation operation 7 times or 8 times at minimum, it is possible to uniformly grind the treatment object (inorganic substance) in the holding tank 3.

Herein, if the circulation flow rate is small, there increases in the holding tank 3 the probability of the presence of particles that have never passed through the grinding mill 2. However, increasing the flow rate can improve uniformity. Such circulation-mode grinding treatment step is superior in dispersion, workability, maintenance, and cleaning easiness, and is also suitable for automation.

In the hydrogen production apparatus 1, for example, solid particles of silicon that is an inorganic substance and water are subjected to a mechanochemical reaction during the grinding treatment. Then, the inorganic substance (treatment object) that has been grinded to the extent that a mechanochemical reaction occurs is reacted with an alkali component (alkali solution), such as sodium hydroxide, which has been fed from an addition port 32 of the holding tank 3, thereby generating hydrogen gas. As the alkali component to be added, besides sodium hydroxide, it is possible to use sodium chloride, potassium hydroxide, sodium carbonate, ammonia aqueous solution, etc.

The hydrogen gas generated in the holding tank 3 is taken out of a discharge port 33. That is, the holding tank 3 according to the present embodiment stores the inorganic substance (treatment object) that is subjected to the grinding treatment by a circulation mode and also becomes a tank for a reaction with the alkali component.

Herein, in the case of adding sodium hydroxide to the water slurry (treatment object slurry) of silicon (treatment object) that has been subjected to the grinding treatment, it is necessary to add sodium hydroxide of an appropriate concentration in accordance with the particle size (specific surface area) of silicon when added. For example, if it is thinner than the optimum concentration, the hydrogen gas production decreases. If sodium hydroxide is added at a concentration thicker than the optimum concentration, the temperature rises due to an abrupt reaction, and a large amount of a hydrogen containing gas is generated in a short period of time, thereby causing the slurry to swell up like a hard caramelized sugar candy.

Next, operation of the hydrogen production apparatus 1 and the hydrogen production method according to the present embodiment will be explained.

The thus configured hydrogen production apparatus 1 according to the present embodiment circulates the treatment object between the grinding mill 2 that agitates and grinds the inorganic substance (treatment object) to be subjected to a mechanochemical reaction with water, and the holding tank 3. The ratio (L/D) of a length (L) in an axial direction to a diameter (D) of the grinding chamber 26a that is formed in the grinding container 21 of the grinding mill 2 is set to be equal to or less than 1.

FIG. 4 is a graph showing experiment results obtained by a comparison of the generated hydrogen amount (mL/g) variation according to the types of the media-agitating-type wet grinding mill and the grinding condition. As the media-agitating-type wet grinding mill, the above-mentioned model name “SC Mill” called beads mill and model name “Attritor” called ball mill were compared.

A media-agitating-type wet grinding mill having a model name “Attritor” can grind the treatment object to have a particle size of 1 μm or smaller by using balls (media) having a particle size of from 3 mm to 10 mm. The hydrogen production was defined as the production per 1 g of silicon that was the treatment object.

As the grinding condition, in the model name “SC Mill”, beads (media) having a particle size ϕ of 0.8 mm were used, and the rotational speed of the agitating rotor 25 was varied to result in 7 m/s, 10 m/s, 13 m/s, and 16 m/s. On the other hand, in the model name “Attritor”, balls (media) having particle sizes ϕ of 3 mm and 5 mm were used, and the rotation number was varied to result in 200 rpm and 300 rpm.

In each model, a sufficient hydrogen production was found to be obtained by extending the grinding time. In particular, it is possible to produce a large amount of hydrogen with a short grinding time by the model name “SC Mill” at a rotation speed of 10 m/s or greater.

In contrast, FIG. 5 is a graph showing experiment results obtained by a comparison of the electric amount (kWh) variation according to the types of the media-agitating-type wet grinding mill and the grinding condition. As the media-agitating-type wet grinding mill, similar to the experiment of FIG. 4, the model name “SC Mill” and the model name “Attritor” were used, and the grinding conditions were the same as those of the experiment of FIG. 4. As a reference, there was shown the amount of electricity necessary for producing 1 Nm3 of hydrogen by an alkali-type water electrolysis.

As understood from these experiment results, it is possible to say that large amounts of hydrogen can be produced at low electric power by using a media-agitating-type wet grinding mill. Furthermore, in the case of setting the rotation speed to 10 m/s with beads having a particle size ϕ 0.8 mm of the model name “SC Mill”, it is possible to reduce the amount of electricity to about 1/2.5, as compared with the case of setting the rotation number to 200 rpm with balls having a particle size ϕ of 3 mm of the model name “Attritor”. Furthermore, as compared with the reference value of the alkali-type water electrolysis, the above-mentioned “SC Mill” (particle size ϕ: 0.8 mm; rotation speed: 10 m/s) can reduce the amount of electricity to about ¼.

Using the model name “SC Mill” in this way makes it possible to produce large amounts of hydrogen at low nominal power (e.g., 3.7 kW). Therefore, it is possible to effectively utilize renewable energy, such as solar power generation and wind power generation. In particular, in the case of not disposing the circulation pump 4 in the circulation line 40, it becomes possible to produce hydrogen with even less electric power.

If the ratio (L/D) of a length (L) in an axial direction to a diameter (D) of the grinding chamber 26a is ⅓ as in the model name “SC Mill”, the pressure loss becomes small, thereby allowing the slurry containing the treatment object to flow at high flow rates. If L/D is small, the resulting centrifugal pump-like structure matches the slurry flow and the centrifugal force direction with each other, and the entire peripheral portion is formed with the separator 26 to result in a very large opening area. This makes it possible to discharge the slurry at high flow rates, thereby enabling the production of large amounts of hydrogen. It also becomes possible to form a pump-less circulation line 40.

In the invention of the hydrogen production method according to the present embodiment, the first step is conducted by the grinding treatment of making a circulation between the grinding mill 2 and the holding tank 3 until the inorganic substance (treatment object) such as silicon gets to have a predetermined particle size. Herein, with respect to whether the inorganic substance (treatment object) has a predetermined particle size or not, the operation is possible by conducting a preliminary test or the like to understand the relationship between the grinding time or the number of circulation and the particle size.

In the second step, an alkali component such as sodium hydroxide is added to the ground inorganic substance (treatment object) stored in the holding tank 3, thereby generating hydrogen gas. In this alkali-component adding step, even if an alkali component thicker than the optimum concentration has been added, allowing the circulation pump 4 to stay stopped makes it possible to prevent the occurrence of a situation that the swollen slurry is fixed to the inside of the grinding mill 2 to interfere with the subsequent operation.

In the case of using a power source such as solar power generation, the time to allow the operation of the grinding mill 2 may be limited by sunlight hours, etc. In such a case, it is possible to generate hydrogen gas by disposing the holding tank 3 of a capacity that makes the treatment possible within an operable time, then proceeding with the mechanochemical reaction while grinding the inorganic substance during daylight as the first step, and then adding an alkali component during night as the second step.

### First Embodiment

In the following, a media-agitating-type wet grinding mill having a grinding mill that is different from the grinding mill 2 explained in the hydrogen production apparatus 1 according to the above embodiment will be explained with reference to FIGS. 6-8. The same terminology or the same symbols will be used to describe parts that are the same as or equivalent to those described in the above embodiment.

The media-agitating-type wet grinding mill to be described in First Embodiment has a grinding mill 5 that is equipped with two agitating rotors 55. That is, the two agitating rotors 55, 55 that are fixed to a rotary shaft 54 to have a space therebetween in the axial direction are disposed in the grinding chamber 56a of the grinding mill 5.

The grinding mill 5 is equipped with a cylindrical grinding container 51, the rotary shaft 54 that passes through one side surface of the grinding container 51 and is rotatably installed, and the two agitating rotors 55 that rotate while fixed to the rotary shaft 54. That is, the solid particles of the inorganic substance (treatment object) that have been put in together with water from the supply port 52 are agitated with media in an grinding chamber 56a of the grinding container 51 by the rotation of the two agitating rotors 55, and the ground inorganic substance (treatment object) and water (treatment object slurry) are discharged from a discharge port 53.

An inner space of the grinding container 51 is divided into the grinding chamber 56a at its center and an outer part 56b at its periphery by a cylindrical separator 56. For the separator 56, it is possible to use, for example, a screen type provided with many slits 561.

The agitating rotor 55 is equipped with a disk-shape holding plate portion 551 that is fixed to the rotary shaft 54, a cylindrical agitating portion 552 that is provided at a periphery of the holding plate portion 551, and a plurality of projection portions 553 that are provided on an outer circumferential surface of the agitating portion 552.

FIG. 7 is a plan view explaining a configuration of the agitating rotor 55. FIG. 8 is a side view taken along a direction of arrows A-A of FIG. 7. The disk-shape holding plate portion 551 is perforated to have a plurality of openings 551a, thereby allowing the treatment object and the media to flow in an axial direction in and out of the agitating rotor 55. The size (inner diameter) of this opening 551a is larger than that of the opening 251a of the agitating rotor 25 of the above grinding mill 2, thereby increasing fluidity. Furthermore, it is perforated to have a plurality of through holes 552a each between the projection portions 553 of the agitating portion 552.

There are two types of projections 553A, 553B that are provided on an outer circumferential surface of the agitating portion 552 to be inclined in opposite directions. When the agitating rotor 55 rotates in a direction of the arrow, front surfaces of the projection portions 553A, 553B become action surfaces to exert an agitating force against the treatment object and the media.

As shown in FIG. 8, the projection portion 553A is provided to be inclined to the axial direction such that a force toward one end of the grinding container 51 is exerted against the treatment object and the media. In contrast, the projection portion 553B is provided to be inclined in a direction opposite to the projection portion 553A such that a force toward the other end of the grinding container 51 is exerted. The projection portions 553A and the projection portions 553B are alternately disposed on the circumference of the agitating rotor 55.

The thus configured grinding mill 5 according to First Embodiment is characterized in that a force toward one end of the grinding container 51 is exerted by the projection portions 553A against the treatment object and the media and that a force toward the other end of the grinding container 51 is exerted by the projection portions 553B against the treatment object and the media.

In short, in conventional media-agitating-type wet grinding mills, only a force toward the other end of the grinding container has been exerted. However, the grinding mill 5 according to First Embodiment has been configured to exert forces toward both ends. With this, the flow toward one end and the flow toward the other end become equally strong, and the flows at the through holes 552a become strong, thereby generating a strong circulation flow over the entire inside of the grinding chamber 56a as shown in FIG. 6.

The thus configured grinding mill 5 of the hydrogen production apparatus 1 according to First Embodiment is such that the ratio (L/D) of the length (L) in an axial direction to the diameter (D) of the grinding chamber 56a that is formed in the grinding container 51 is set to be equal to or smaller than 1 and to be greater than ⅓.

Even if the ratio (L/D) of the length (L) in an axial direction to the diameter (D) of the grinding chamber 56a is greater than ⅓, it can be operated at lower electric powers than when the ratio (L/D) is ⅓ by attaching two agitating rotors 55 to the rotary shaft 54 of the grinding chamber 56a and by optimizing the shape of the projection portions 553A, 553B of the agitating rotor 55.

Since other configurations and effects are generally the same as those of the above embodiment or other examples, their explanations are omitted.

### Second Embodiment

A hydrogen production apparatus 1A according to Second Embodiment which is different from the hydrogen production apparatus 1 according to the above embodiment will be explained with reference to FIGS. 9A and 9B. The same terminology or the same symbols will be used to describe parts that are the same as or equivalent to those described in the above embodiment or First Embodiment.

In the hydrogen production apparatus 1 according to the above embodiment, the capacity of the holding tank 3 has not been particularly limited. In the hydrogen production apparatus 1A that is explained in Second Embodiment, a large capacity tank is used as the holding tank 3A.

FIG. 9A is an explanatory view of a configuration of the hydrogen production apparatus 1A according to Second Embodiment. FIG. 9B is an explanatory view of a configuration in which a small capacity tank a3 is disposed for showing a comparison. In the case of increasing the circulation flow rate to produce large amounts of hydrogen, a generally used small-capacity tank a3 may not be enough. Herein, the small capacity tank a3 has a capacity that is about 10 times that of the grinding chamber 26a of the grinding mill 2.

In contrast with this, the holding tank 3A disposed in the hydrogen production apparatus 1A is formed into a large capacity tank having a capacity that is 300 or more times that of the grinding chamber 26a to be formed in the grinding container 21 of the grinding mill 2. With this, it becomes possible to uniformly grind the inorganic substance (treatment object) in the holding tank 3A. On this occasion, the treatment time extends in proportion to the treatment amount.

The thus configured hydrogen production apparatus 1A according to Second Embodiment can conduct the treatment in large amounts by disposing a large capacity tank having a capacity 300 or more times that of the grinding chamber 26a as the holding tank 3A and by using a small media-agitating-type wet grinding mill (grinding mill 2, 5) that operates at low nominal electric power (e.g., 3.7 kW).

For example, in the case of using a power source such as a small-scale hydroelectric power generation, the power supply will be stable to some extent throughout the day. However, large electric motors may not be available since the electric power source capacity is limited. In such a case, it becomes possible to conduct a treatment of producing large amounts of hydrogen by connecting the holding tank 3A of a large capacity to a small media-agitating-type wet grinding mill (grinding mill 2, 5) that is operated at low nominal electric power.

By forming the holding tank 3A into a large capacity tank, the grinding speed becomes slow. Therefore, it becomes possible to easily conduct the operation while adding an alkali component such as sodium hydroxide to the holding tank 3A. That is, since an abrupt reaction is suppressed, swelling up of the slurry does not occur. There does not occur a situation that solids are fixed to the inside of the holding tank 3A or the grinding mill 2 to interfere with the operation.

Since other configurations and effects are generally the same as those of the above embodiment or other examples, their explanations are omitted.

### Third Embodiment

In the following, a hydrogen production apparatus 1B and a hydrogen production method according to Third Embodiment, which are different from the hydrogen production apparatuses 1, 1A according to the above embodiment and First and Second Embodiments, will be explained with reference to FIG. 10. The same terminology or the same symbols will be used to describe parts that are the same as or equivalent to those described in the above embodiment or First and Second Embodiments.

In the hydrogen production apparatus 1, 1A according to the above embodiment and First and Second Embodiments, it is assumed that an alkali component is added to the holding tank 3, 3A to generate hydrogen in the holding tank 3, 3A.

In contrast with this, in the hydrogen production apparatus 1B according to Third Embodiment, a reaction tank 6 for generating hydrogen gas by adding an alkali component is separately provided, apart from the holding tank 3B for the grinding treatment.

In other words, the hydrogen production apparatus 1B according to Third Embodiment is equipped with the grinding mill 2 as a media-agitating-type wet grinding mill, the holding tank 3B of the inorganic substance (treatment object), the circulation line 40, the reaction tank 6 having a port 62 for adding an alkali component, and a feed line 70 that is connected to the circulation line 40 for feeding the treatment object to the reaction tank 6. Herein, according to need, the circulation pump 4 is disposed in the circulation line 40.

Since the holding tank 3B according to Third Embodiment is only used for the grinding treatment step, it is provided with only an input port 31 that serves as an input port of the treatment object slurry and a return port after the circulation. On the other hand, the reaction tank 6 is provided with an inflow port 61 of the treatment object slurry, a port 62 for adding an alkali component, an agitator 64, and a discharge port 63 for taking out hydrogen gas generated in the reaction tank.

The circulation line 40 and the reaction tank 6 are connected by the feed line 70 whose end is connected to a valve 41 that becomes a branch part of the circulation line 40. A pump 7 is provided in the middle of the feed line 70.

In the hydrogen production method by using the thus configured hydrogen production apparatus 1B according to Third Embodiment, firstly the grinding treatment step is conducted in the circulation line 40 for a predetermined time. After the set grinding time has elapsed, the pump 7 is activated to send the treatment object slurry to the reaction tank 6 by the feed line 70.

In the subsequent hydrogen gas generation step, an alkali component such as sodium hydroxide is added from the addition port 62 of the reaction tank 6 to generate hydrogen while agitating the treatment object slurry by the agitator 64. Then, the generated hydrogen gas is taken out of the discharge port 63.

In the thus configured hydrogen production apparatus 1B and the hydrogen production method according to Third Embodiment, the reaction tank 6 for adding an alkali component is provided, apart from the holding tank 3B that is used for conducting a mechanochemical reaction between water and the inorganic substance (treatment object).

Herein, in the case of adding sodium hydroxide (alkali component) to a water slurry of ground silicon (treatment object), it is necessary to add sodium hydroxide of an optimum concentration in accordance with the particle size (specific surface area) of silicon. However, it is difficult to correctly know the particle size in real time in the middle of grinding.

In contrast with this, only water and silicon are put into the holding tank 3B that is used for the grinding treatment, followed by grinding in a neutral or acidic region in the circulation line 40 where the grinding mill 2 is present to obtain a required particle size, thereby producing a fine-particle silicon water slurry with an active particle surface by a mechanochemical reaction.

Then, the fine-particle silicon water slurry is fed to the reaction tank 6 by switching the valve 41 of the circulation line 40, followed by adding sodium hydroxide there. With this, it becomes possible to safely generate large amounts of hydrogen to recover a high purity hydrogen gas.

By separation into the grinding treatment step and the hydrogen gas generation step, while hydrogen is generated in the reaction tank 6, it is possible to simultaneously proceed with the next silicon grinding treatment step by using the holding tank 3B. Therefore, it is suitable for continuous production.

Furthermore, in case that silicon is ground in water between acidic region and neutral region, the amount of hydrogen to be generated is limited to a small amount. Therefore, the pressure-resistant design of the grinding mill 2 and its incidental equipment can be simplified. That is, it becomes possible to safely, efficiently and continuously produce hydrogen.

Since other configurations and effects are generally the same as those of the above embodiment or other examples, their explanations are omitted.

As above, the embodiment and the examples of the present invention have been described in detail. However, specific configurations are not limited to the above embodiment and First to Third Embodiments. Design changes are included in the present invention as long as they do not deviate from the gist of the present invention.

For example, in the above embodiment or First Embodiment, the grinding mill 2, 5 in which the ratio (L/D) of the length (L) in an axial direction to the diameter (D) of the grinding chamber 26a, 56a becomes equal to or less than 1 has been explained as an example, but it is not limited to this. It is also possible to use a media-agitating-type wet grinding mill in which L/D becomes greater than 1.

In the above embodiment or Second Embodiment or Third Embodiment, there has been explained the case in which an alkali component (alkali solution) such as sodium hydroxide is put therein from the addition port 32 of the holding tank 3 or the addition port 62 of the reaction tank 6, but it is not limited to this. It is also possible to produce hydrogen gas by putting therein an acid component (acid solution) such as sulfuric acid or nitric acid from the addition port 32, 62 to conduct the reaction.

1. A hydrogen production apparatus for producing hydrogen by a mechanochemical reaction between water and a treatment object that is an inorganic substance, the hydrogen production apparatus comprising:
a media-agitating-type wet grinding mill comprising a supply port, a discharge port of the treatment object, and a cylindrical grinding container;
a holding tank of the treatment object that is treated by the media-agitating-type wet grinding mill; and
a circulation line configured to circulate the treatment object and water between the media-agitating-type wet grinding mill and the holding tank.

2. The hydrogen production apparatus according to claim 1, wherein a ratio (L/D) of a length (L) in an axial direction to a diameter (D) of a grinding chamber that is formed in the cylindrical grinding container is equal to or less than 1.

3. The hydrogen production apparatus according to claim 2, wherein the ratio (L/D) of the length (L) in the axial direction to the diameter (D) of the grinding chamber is equal to or less than ⅓.

4. The hydrogen production apparatus according to claim 2, wherein two agitating rotors are attached to a rotary shaft to have a space therebetween in the axial direction and are disposed in the grinding chamber, and
wherein one agitating rotor comprises a disk-shaped holding plate portion that is fixed to the rotary shaft and has a plurality of openings, a cylindrical agitating portion that is provided at a periphery of the disk-shaped holding plate portion and has a plurality of through holes, and a projection portion that is provided on an outer circumferential surface of the cylindrical agitating portion.

5. The hydrogen production apparatus according to claim 2, wherein the holding tank is a large capacity tank that is formed to have a volumetric capacity 300 or more times a volumetric capacity of the grinding chamber formed in the cylindrical grinding container.

6. The hydrogen production apparatus according to claim 1, wherein the treatment object contains at least one element selected from a group consisting of silicon, aluminum, iron, germanium, tin, titanium, calcium, zinc, chromium, manganese, zirconium, strontium, silver, phosphorus, magnesium, vanadium, nickel, molybdenum, copper, tungsten, cobalt, lithium, barium, sodium, potassium, or rubidium.

7. The hydrogen production apparatus according to claim 1, further comprising a reaction tank having a port to add an alkali component or an acid component, and a feed line that is connected to the circulation line to feed the treatment object to the reaction tank.

8. A hydrogen production method for producing hydrogen by a mechanochemical reaction between water and a treatment object that is an inorganic substance, the hydrogen production method comprising:
conducting a grinding treatment by circulating the treatment object and water between a media-agitating-type wet grinding mill that has a cylindrical grinding container and a holding tank; and
generating a hydrogen gas by adding an alkali component or an acid component to the treatment object that has been subjected to the grinding treatment and water.
